(19) United States
(12) Patent Application Publication
(10) Pub. No.: US 2015/0020796 A1
(43) Pub. Date: Jan. 22, 2015

(54) Grill and Method of Assembling Same

(71) Applicant: Hamilton Beach Brands, Inc., Glen Allen, VA (US)

(72) Inventors: Michael Garman, Moseley, VA (US); Michael G. Sandford, Mechanicsville, VA (US)

(21) Appl. No.: 14/511,476

(22) Filed: Oct. 10, 2014

Related U.S. Application Data
(63) Continuation-in-part of application No. 14/017,801, filed on Sep. 4, 2013.
(60) Provisional application No. 61/698,104, filed on Sep. 7, 2012.

(51) Int. Cl. A47J 37/07; B23P 19/00

(52) U.S. Cl. CPC A47J 37/0763; B23P 19/00; A47J 37/0704; A47J 2037/0777
USPC 126/9 B; 29/428

(57) ABSTRACT

A grill includes a cooking unit defining a heating cavity for receiving and heating foodstuff. A base supports the cooking unit above a support surface. The base includes a first side baffle and an opposing second side baffle. The first and second side baffles are movable between a compact configuration, wherein the first and second side baffles extend generally parallel to the support surface, and an expanded configuration, wherein the first and second side baffles extend generally perpendicularly to the support surface. At least one brace stabilizes the grill in the expanded configuration

### CROSS-REFERENCE TO RELATED APPLICATIONS

This application is a continuation-in-part of co-pending U.S. application Ser. No. 14/017,801, filed Sep. 4, 2013, entitled “Grill and Method of Assembling Same”, which claims priority to U.S. Provisional Application No. 61/698,104, filed Sep. 7, 2012, entitled “Grill and Method of Assembling Same,” the subject matter of each of which is herein incorporated by reference in their entireties.

### BACKGROUND OF THE DISCLOSURE

The present disclosure is directed to a grill and a method of assembling a grill and, more particularly, to an outdoor barbeque grill that can be stored or transported in a compact state and assembled or erected in a relatively short amount of time and generally without the use of tools.

Barbeque grills, such as those on outdoor decks, patios and the like, are well known. Conventional grills can be relatively large and unwieldy. As a result, conventional grills can be costly to store or transport. In addition, conventional grills include a multitude of separate parts or components that must be properly assembled prior to use. Since many retailers do not assemble conventional grills at least due to the increased cost in doing so, many consumers are required to perform the time consuming and often frustrating task of assembling the grills prior to first use.

In light of the above, certain grills have been designed to collapse or assemble in a relatively quick time period. However, conventional collapsible grills include a multitude of moving components that are difficult, awkward and/or time consuming to properly configure. In addition, conventional collapsible grills are not aesthetically pleasing and at least give the appearance of instability being cheaply made.

It has heretofore not been discovered how to create a grill that is capable of being stored or transported in a generally compact configuration and being assembled to a generally expanded use configuration in a relatively short period of time and generally without the use of tools. The device of the following disclosure accomplishes the above and other objectives and overcomes at least the above-described disadvantages of conventional grills.

### BRIEF SUMMARY OF THE DISCLOSURE

Briefly stated, one aspect of the present disclosure is directed to a method of assembling a grill. The method comprises the steps of (i) placing the grill in a compact configuration on an underlying support surface, such that a base of the grill engages the support surface with opposing first and second side baffles of the base extending generally parallel to the support surface; (ii) raising an upper portion of the grill upwardly with respect to the support surface and maintaining at least a lower portion of the base in contact with the support surface, such that the first and second side baffles unfold from the compact configuration to an expanded configuration of the base, the first and second side baffles extending generally perpendicularly to the support surface to support the upper portion of the grill; and (iii) installing at least one brace to stabilize the grill in the expanded configuration.

In another aspect, the present disclosure is directed to a grill including a cooking unit defining a heating cavity for receiving and heating foodstuff and a base supporting the cooking unit atop a support surface. The cooking unit includes a lid for selectively opening and closing the heating cavity. The base includes a first side baffle and an opposing second side baffle, wherein the first and second side baffles are movable between a compact configuration, wherein the first and second side baffles extend generally parallel to the support surface, and an expanded configuration, wherein the first and second side baffles extend generally perpendicularly to the support surface. At least one brace stabilizes the grill in the expanded configuration.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a front perspective view of a grill in accordance with a first embodiment of the present disclosure, wherein the grill is shown in a fully assembled configuration;

FIG. 2 is a rear bottom perspective view of the grill of FIG. 1;

FIG. 3 is a front perspective schematic view of the grill of FIG. 1, wherein the grill is shown is a storage or transport configuration;

FIG. 4 is a front perspective schematic view of the grill of FIG. 1, wherein the grill is shown in a partially assembled configuration;

FIG. 5 is a front perspective schematic view of the grill of FIG. 1, wherein the grill is shown in another partially assembled configuration;

FIG. 6 is a front perspective schematic view of the grill of FIG. 1, wherein the grill is shown in a yet another partially assembled configuration;

FIG. 7 is a front perspective schematic view of the grill of FIG. 1, wherein the grill is shown in still another partially assembled configuration;

FIG. 8 is a front perspective schematic view of the grill of FIG. 1, wherein the grill is shown in a further partially assembled configuration;

FIG. 9 is a front perspective schematic view of the grill of FIG. 1, wherein the grill is shown in a yet a further partially assembled configuration;

FIG. 10 is a front perspective schematic view of the grill of FIG. 1, wherein the grill is shown in still a further partially assembled configuration;

FIG. 11 is a front perspective schematic view of the grill of FIG. 1, wherein the grill is shown in an additional partially assembled configuration;

FIG. 12 is a front perspective schematic view of the grill of FIG. 1, wherein the grill is shown in yet an additional partially assembled configuration;

FIG. 13 is a front perspective schematic view of the grill of FIG. 1, wherein the grill is shown in still an additional partially assembled configuration;

FIG. 14 is a front perspective schematic view of the grill of FIG. 1, wherein the grill is shown in an advanced partially assembled configuration;

FIG. 15 is a front perspective schematic view of the grill of FIG. 1, wherein the grill is shown in yet a more advanced partially assembled configuration;

FIG. 16 is a front perspective schematic view of the grill of FIG. 1 in a fully assembled configuration;

FIG. 17 is a cross-sectional partial top perspective view of a base of the grill of FIG. 1 in a partially assembled configuration, taken along the sectional line 5-5 of FIG. 5

FIG. 18 is a front elevational view of the grill of FIG. 1 in a partially assembled configuration;

FIG. 19 is a rear elevational view of the grill of FIG. 1 in a fully assembled configuration;

FIG. 20 is a front perspective view of a grill in accordance with a second embodiment of the present disclosure, wherein the grill is shown being assembled;

FIG. 21 is a front perspective view of the grill of FIG. 16 in a further stage of assembly; and

FIG. 22 is a front perspective view of the grill of FIG. 16 in yet a further state of assembly.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

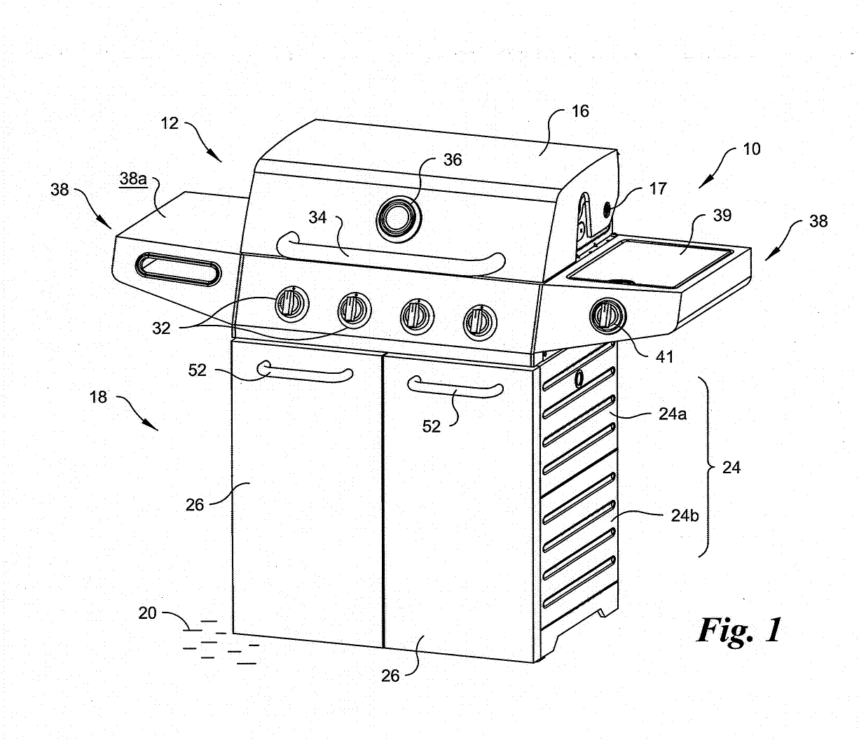

Referring to the drawings in detail, wherein like numerals indicate like elements throughout, FIGS. 1-19 illustrate a grill, generally designated 10, in accordance with a first preferred embodiment of the present disclosure. The grill 10 is intended or designed for heating, cooking or otherwise preparing foodstuff (none shown) to be consumed by a user. As described in detail below, the grill 10 eases and/or expedites initial set-up for the manufacturer, the retailer and/or the end consumer/user. The grill 10 may be an outdoor barbeque grill powered by fuel, such as propane, natural gas or the like. However, the present disclosure is not limited by the type of grill or the foodstuff (not shown) prepared by the user. For example, the grill 10 may be powered by electricity or charcoal, for example, or may be used as a rotisserie.

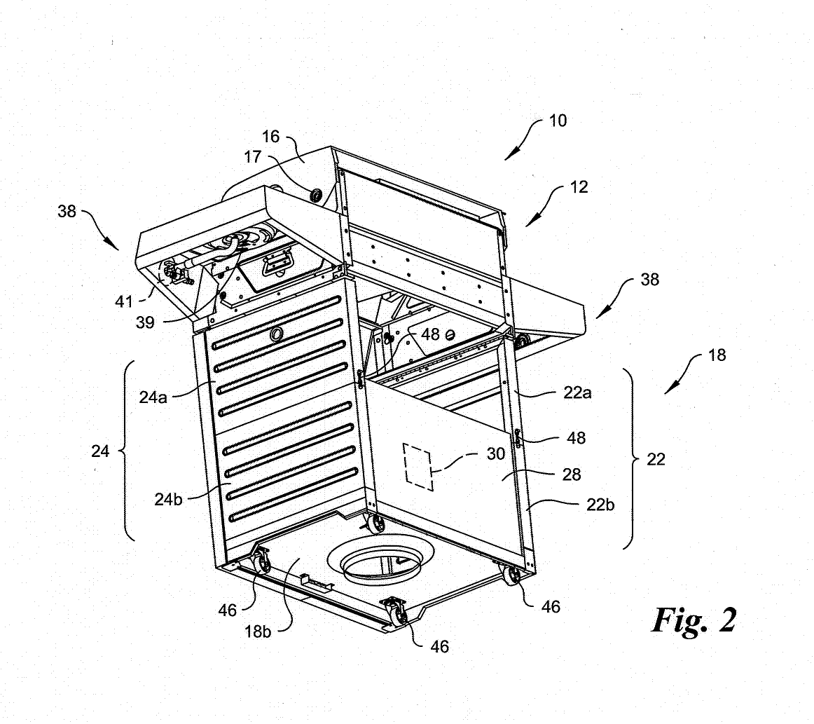

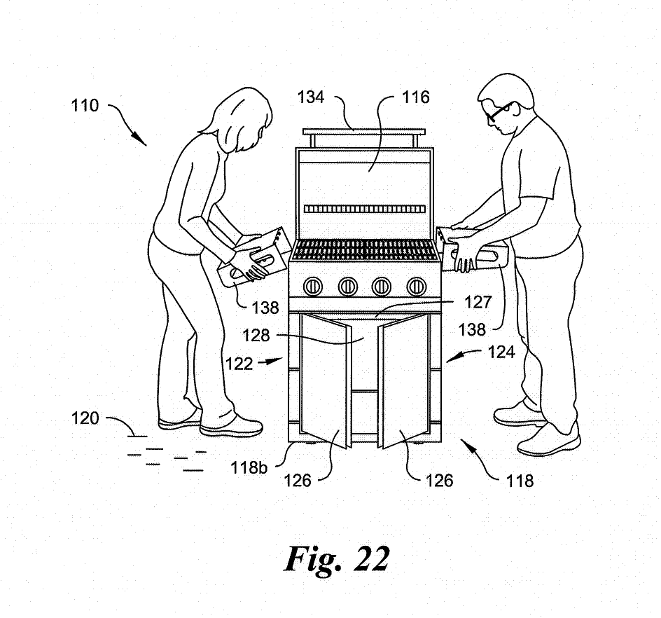

As shown in FIGS. 1-22, the grill 10 includes a cooking unit 12 that defines a heating cavity 14 (FIGS. 12-16) for receiving and heating foodstuff. The cooking unit 12 or a portion thereof may be referred to as a “fire box.” The cooking unit 12 may contain one or more spaced-apart burners (not shown) operatively connected to fuel, such as propane in a tank 30 (shown in phantom in FIG. 2), natural gas or electricity. The burners convert potential energy in the form of fuel or electricity into kinetic energy in the form of a flame or heat. Alternatively, the burners may operatively connect to a natural gas line (not shown), as is understood by those skilled in the art.

An exterior of the cooking unit 12 may include one or more control dials or buttons 32, which allow a user to control operation of the burners. Operation of the burners and the control dials 32 is well known to those skilled in the art and, therefore, will not be described in further detail herein. The cooking unit 12 is not limited to the inclusion of burners and/or control dials 32, as the cooking unit 12 may be used to hold charcoal or another burning medium to heat the foodstuff, as is understood by those skilled in the art.

The cooking unit 12 includes a lid 16 that is pivotable or removable to allow the user to selectively open and close the heating cavity 14. One or more hinges 17 (FIG. 2) may pivotally attach a rear portion of the lid 16 to a rear portion of the cooking unit 12. The term “hinge” is broadly defined herein is any type of joint or bearing, such as a barrel hinge, a concealed hinge and the like. As shown in FIG. 1, a handle 34 may extend outwardly from a portion of the lid 16 to assist the user in opening and/or closing the lid 16. A temperature indicator 36 (FIG. 1) may be mounted on a front side of the lid 16 and operatively connected to a thermometer (not shown) on or within the cooking unit 12 to display a temperature of the heating cavity 14. The foodstuff may be heated within the heating cavity 14 with the lid 16 either in the open (FIG. 16) or the closed (FIG. 1) positions, or any position therebetween.

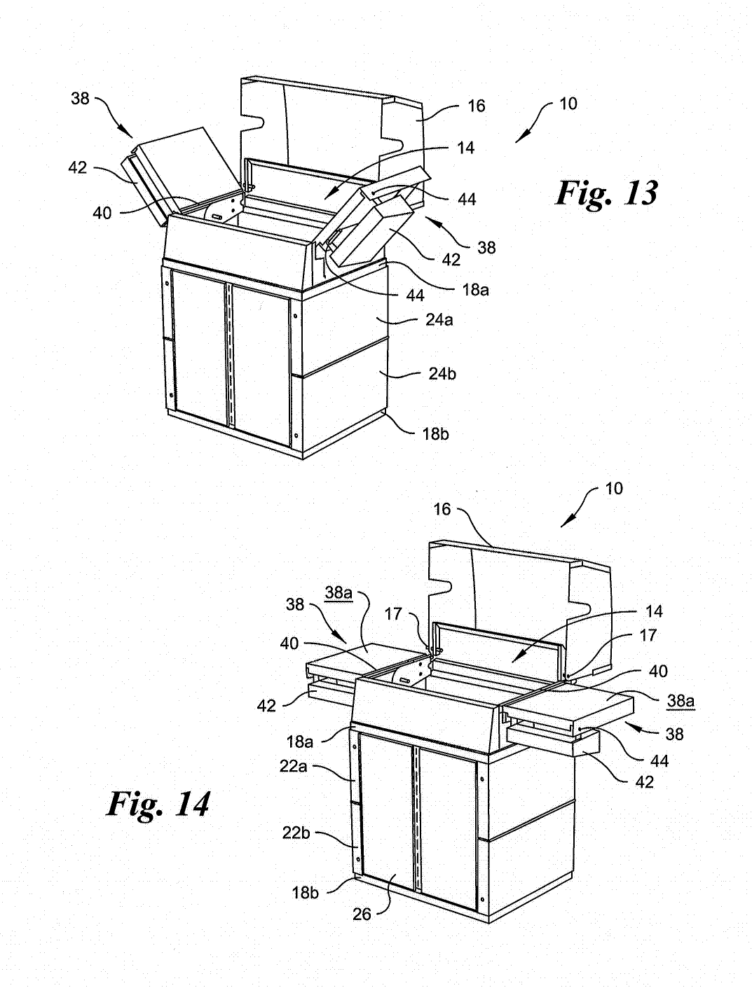

The grill 10 may include one or more shelves 38 that allow the user to support or suspend foodstuff or other objects (such as utensils or plates) above the deck, grand or other support surface 20. Additionally, as shown in FIGS. 1 and 2, either or both of the shelves 38 may include a skillet or additional burner 39 that may be controlled by an additional control knob or button 41. When the grill 10 is in use, the shelves 38 preferably extend laterally outwardly from the cooking unit 12 in a use position. In the use position, a top surface 38a of each shelf 38 preferably extends in the same or generally the same plane as a grate (not shown) within the heating cavity 14 that supports the foodstuff to be heated. When the grill 10 is not in use, the shelves 38 may be placed or otherwise stored entirely within the cooking unit 12 and/or the heating cavity 14 in a storage position. The shelves 38 may be pivotally attached to the cooking unit 12 or removably attachable thereto. In particular, one or more hinges 40 (see FIGS. 13-16) may attach a portion of each shelf 38 to an outer peripheral portion of the cooking unit 12. Alternatively, the shelves 38 may be separable from the cooking unit 12 and reattached in a desired position or orientation, as described below with respect to the second embodiment of the present disclosure. Following use of the grill 10, the shelves 38 may be pivoted or moved inwardly into the heating cavity 14 of the cooking unit 12 (see FIG. 12).

Referring to FIGS. 12-16, either or both of the shelves 38 may include a tray 42 attached thereto. One or more hinges 44 may pivotally attach each tray 42 to the respective shelf 38. Each tray 42 preferably folds beneath or above the respective shelf 38 so as to fit within the heating cavity 14 of the cooking unit 12 when the lid 16 is in a closed position. When the shelves 38 are in the open or expanded position (see FIGS. 14-16), the respective tray 42 preferably pivots or unfolds outwardly from below the shelf 38 toward the front of the grill 10. Each tray 42 may be pivoted to the outward or use position (see FIGS. 14-16) for aesthetic purposes. Alternatively or additionally, each tray 42 may include one or more buttons, knobs, levers or switches (not shown) that provide the user with additional control over the grill 10.

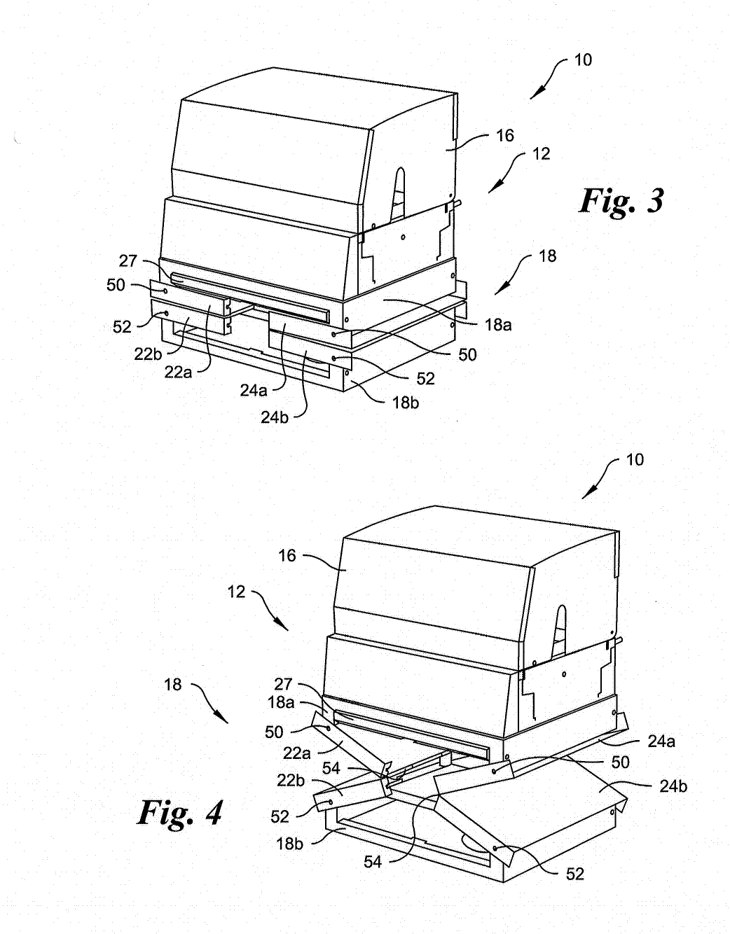

The grill 10 also includes a base 18 that supports the cooking unit 12 above a support surface 20. The support surface 20 may be the ground surface, such as a deck, a patio or grass. However, the support surface 20 may be a table top, a counter top or at least a portion of another support structure. As shown in FIGS. 3-16, an upper portion or top 18a of the base 18 is preferably fixedly attached to a lower end or bottom of the cooking unit 12. However, the base 18 may be removably attachable to the cooking unit 12. An outer periphery of the base 18 preferably at least generally, if not exactly, matches an outer periphery of the bottom of the cooking unit 12. As shown in FIG. 2, one or more spaced-apart castors or wheels 46 may be attached to and extend downwardly from a lower portion or bottom 18b of the base 18.

A distinguishing feature of the grill 10 is that the base 18 provides the capability for the grill 10 to expand and/or collapse between a fully assembled configuration (FIG. 1) and a storage or transportation configuration (FIG. 3) in a relatively short amount of time (e.g., less than 60 seconds). The above-described reconfiguration can be accomplished generally or completely without the use of conventional tools (not shown), such as a hammer or a screwdriver. In essence, the base 18 is composed of a plurality of walls or panels that fold or bend into a generally compact configuration (see FIG. 3), which allows a plurality of grills 10 to be stored and/or transported in a finite amount of space. The base 18 folds and unfolds, or collapses and expands, without increasing the overall footprint of the base 18. A single user may collapse or expand the base 18, or two opposing users may combine to collapse or expand the base, as described in detail below.

In particular, referring to each of FIGS. 1-16, the base 18 includes a first or left side baffle 22 and an opposing second or right side baffle 24. The side baffles 22, 24 may be referred to herein as “legs” or sidewalls of the base 18, and each preferably provides a continuous surface to enclose an interior of the base 18. Each side baffle 22, 24 includes a generally flat or planar first plate 22a, 24a pivotally attached to a generally flat or planar second plate 22b, 24b. The first plates 22a, 24a may be pivotally attached to the top 18a of the base 18 by one or more hinges 50 (see FIGS. 3 and 4). Similarly, the second plates 22b, 24b may be pivotally attached to the bottom 18b of the base 18 by one or more hinges 52 (see FIGS. 3 and 4).

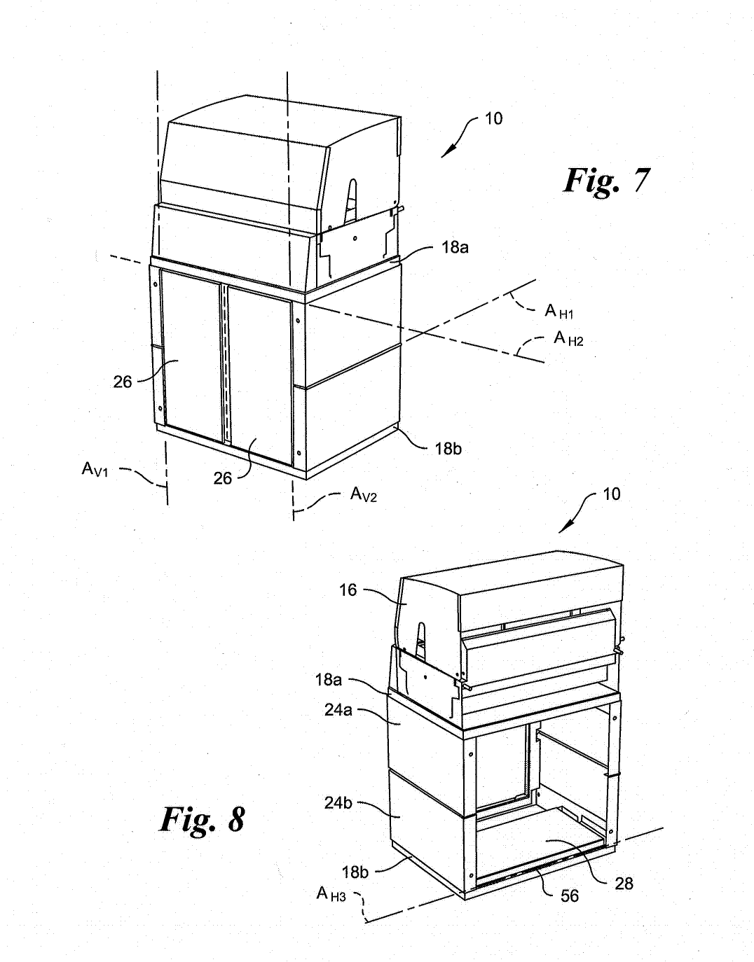

As shown in FIG. 4, one or more hinges 54 preferably pivotally attach the first and second plates 22a, 22b, 24a, 24b, respectively, about a first horizontal axis A_{H1} (see FIG. 7). The plates 22a, 22b, 24a, 24b are pivotable between a first, folded or collapsed (compact) configuration (see FIG. 3) and a second, unfolded or assembled (expanded) configuration (see FIGS. 1, 2 and 5-16). In the first configuration, the plates 22a, 22b, 24a, 24b extend generally, if not exactly, parallel to one another and the support surface 20. Exterior surfaces of the respective pair of plates 22a, 22b, 24a, 24b may be in engagement or contact when in the first configuration. In the second configuration, the plates 22a, 22b, 24a, 24b extend generally parallel to, and abutting, one another and generally perpendicularly to the support surface 20. When the plates 22a, 22b, 24a, 24b are in the second configuration, the cooking unit 12 is preferably raised a predetermined height from the support surface 20 so as to be ergonomically comfortable for the user to operate the grill 10. Each plate 22a, 22b, 24a, 24b may have a height that is generally, if not exactly, one half of the total height of the base 18 and/or each side baffle 22, 24.

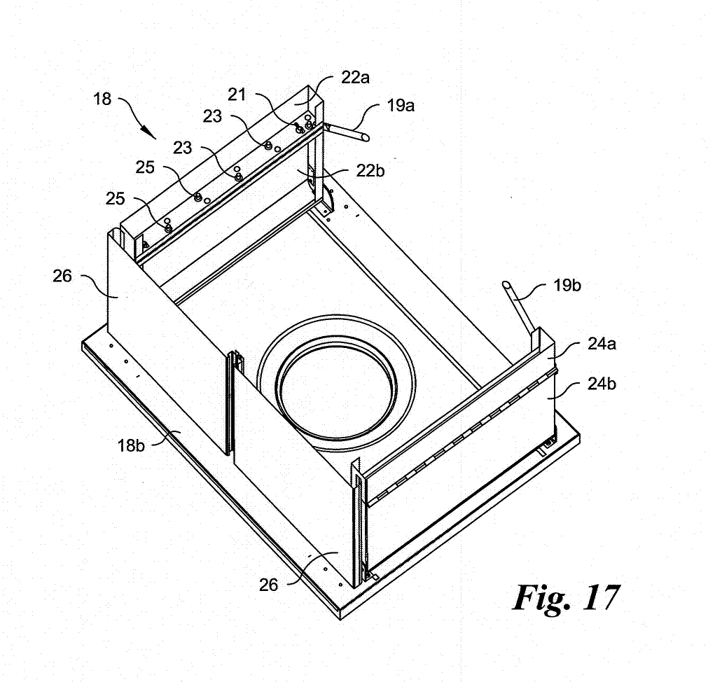

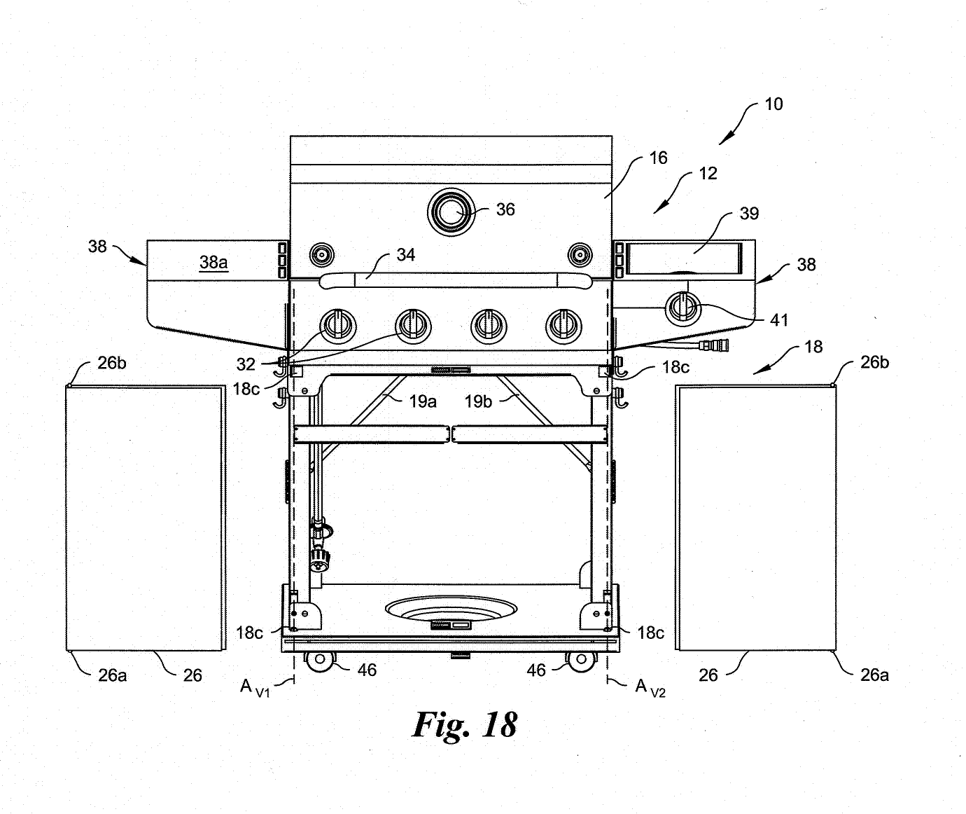

In some embodiments, as shown, for example, in FIG. 17, each lower plate 22b, 24b may also include at least one threaded pin 25 extending upwardly from an upper end of the lower plate 22b, 24b, and each upper plate 22a, 24a may also include a corresponding at least one complimentary slot 23 in a lower end of the upper plate 22a, 24a. Pivoting of the plates 22a, 22b, 24a, 24b from the first, compact configuration to the second, expanded configuration, moves the threaded pin(s) 25 to project through the corresponding slot(s) 23. Thereafter, a fastener 21, e.g., a wing nut, is threaded onto a respective corresponding threaded pins 25 to secure the first and second side baffles 22, 24 in the expanded configuration.

As shown in FIGS. 1, 2 and 6-16, the base 18 includes at least one and preferably a pair of pivotable doors 26. The doors 26 may be partially or completely surrounded by a frame 27 (FIGS. 3-6) that allows the user to move the doors 26 as a single unit into and out of a first, folded or collapsed configuration, through a partially unfolded configuration (FIG. 6), and to a second, unfolded or assembled configuration (FIGS. 1, 2 and 7-16). In the first configuration, it is preferred that the door(s) 26 is/are proximate to or at least partially in contact with the top 18a of the base 18. However, the door(s) 26 may be proximate to or at least partially in contact with the bottom 18b of the base 18 when the door(s) 26 is/are in the first configuration. In the first configuration, the door(s) 26 is/are preferably positioned entirely within an outer periphery of the base 18. From the first configuration, the doors(s) 26 is/are moved downwardly or upwardly within the interior of the base 18 to the second configuration, such that the door(s) 26 form(s) a front wall of the base 18.

One or more hinges (none shown) may pivotally attach the frame 27 to a remainder of the base 18, such as the top 18a or bottom 18b thereof. The frame 27 is preferably pivotable about a second horizontal axis A_{H2} (see FIG. 7). The second horizontal axis A_{H2} preferably extends generally, if not exactly, perpendicularly to the first horizontal axis A_{H1}. Each door 26 is preferably pivotally attached to the frame 27, so that each door 26 can pivot or open outwardly about a vertical axis A_{V1}, A_{V2} (see FIG. 7) to expose an interior of the base 18. The vertical axes Aᵥ₁, A_{V2} extend generally, if not exactly, perpendicularly to the first horizontal axis A_{H1}. As shown in FIG. 1, a handle 52 may extend outwardly from a portion of each door 26 to assist the user in opening and/or closing the door 26. Alternatively, each door 26 may be devoid of a handle, and the doors 26 may be opened by simply grasping a portion of the door 26 or pressing at least slightly inwardly on the door 26 to release a spring-biased catch (not shown).

Alternatively, the door(s) 26 may be removably attached to the front face of the base 18, and pivotable about one, or both of the vertical axes A_{V1}, A_{V2}. For example, as shown in FIG. 18, the door(s) 26 may include an arcuate shaped member 26a, e.g., a ball, fixedly projecting from a lower corner of the door 26 and a spring loaded arcuate shaped member 26b, projecting from an axially spaced, i.e., along the same vertical axis, upper corner of the door 26. The top 18a and bottom 18b of the base 18 may include opposing detents 18c, corresponding to each of the arcuate shaped members 26a, 26b. Therefore, to assemble the door(s) 26 to the base 18, the fixed lower member 26a is placed in one corresponding detent 18c and the spring loaded upper member 26b is compressed against the force of the spring to snap into the other corresponding detent 18c, thereby pivotably attaching door(s) 26 to the base 18 about one of the vertical axes A_{V1}, A_{V2}. As should be understood by those of ordinary skill in the art, however, the spring loaded member 26b may alternatively be located on the lower corner of the door 26 and the fixed member 26a located on the upper corner of the door 26, or, alternatively, the top 18a and bottom 18b portions of the base 18 may include the members 26a, 26b, and the door 26 may include the detents 18c. As also should be understood, the door(s) 26 may be removably and pivotably attached to the base 18 via any of numerous different attachment means, currently known or that later become known.

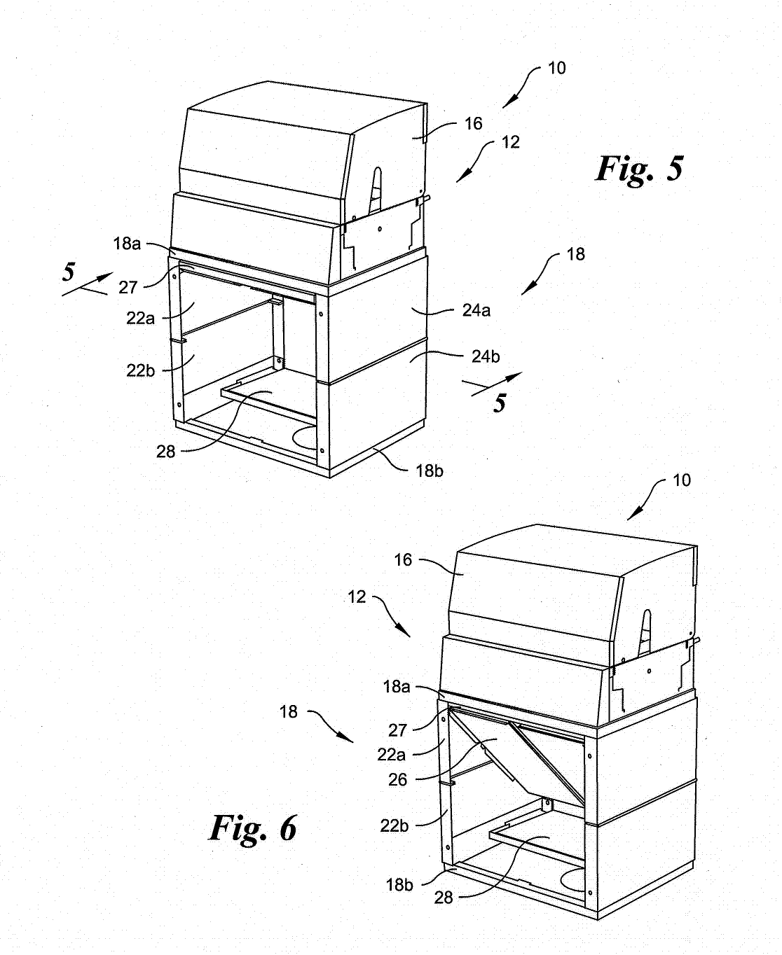

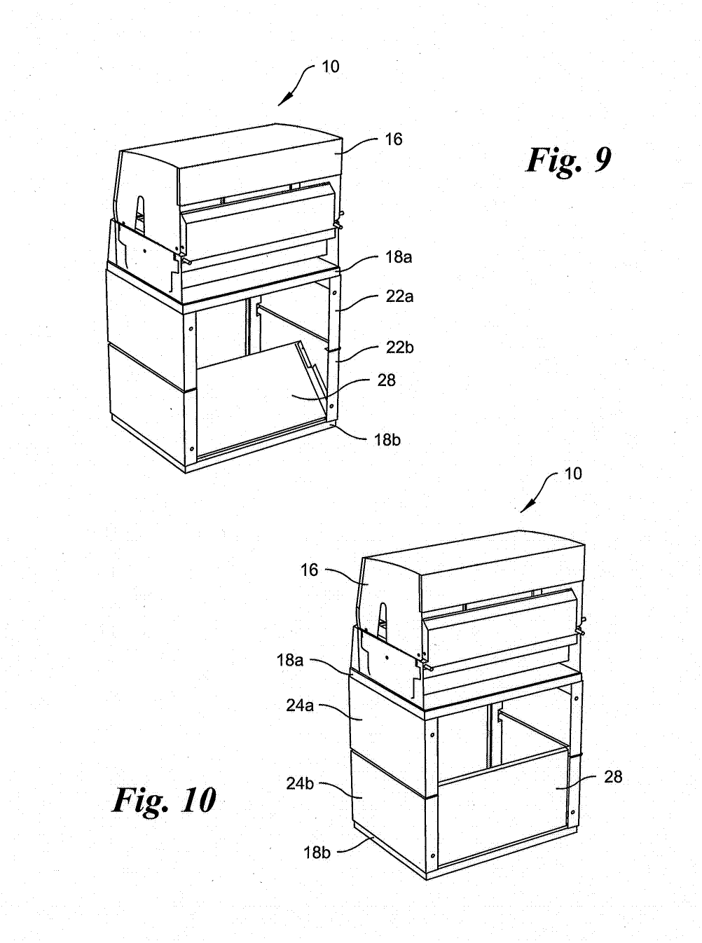

Referring to FIGS. 2, 5, 6 and 8-10, the base 18 may include a third rear baffle 28 movable between a first, folded or collapsed configuration (see FIGS. 5, 6 and 8) at or near the bottom 18b or the top 18a of the base 18, through a partially unfolded configuration (see FIG. 9), and to a second, unfolded or assembled configuration (see FIGS. 2 and 10). The third rear baffle 28 extends generally, if not exactly, perpendicularly to the first and second side baffles 22, 24 when the third rear baffle 28 is in the unfolded configuration. The third rear baffle 28 may extend proximate to and generally parallel with the bottom 18a of the base 18 and may be pivoted upwardly within the interior of the base 18 to move from the first configuration to the second configuration. As shown in FIG. 8, one or more hinges 56 may pivotally attach the third rear baffle 28 to a reminder of the base 18 about a third horizontal axis A_{H3} (see FIG. 8). The third horizontal axis A_{H3} extends generally, if not exactly, perpendicularly to the first horizontal axis A_{H1} and generally, if not exactly, parallel to the second horizontal axis A_{H2}.

As shown in FIG. 2, a height of the third rear baffle 28 may be greater than that of any one of the plates 22a, 22b, 24a, 24b, but less than the total height of the base 18 and/or each side baffle 22, 24. As a result, a gap or spacing may exist between a top of the third rear baffle 28 and a bottom of the cooking unit 12 when the grill 10 is in the fully assembled configuration. When the grill 10 is in the fully assembled configuration (see FIGS. 1 and 2), the first and second side baffles 22, 24, the third rear baffle 28 and the doors 26 generally surround the tank 30 and/or the interior cavity of the base 18. The third rear baffle 28 may be moved into the desired position (FIGS. 2 and 10) before or after the door(s) 26 are moved into the desired position (FIGS. 1 and 7). Those skilled in the art realize that the above-described features of the base 18 are not limited to use as part of a grill 10 and/or with a cooking unit. For example, the base 18 could be used to support nearly any structure, such as a beverage cooler, a stereo, a table top or the like, above the support surface 20.

The first and second side baffles 22, 24, the third rear baffle 28 and the doors 26 of the base 18 are preferably formed of a light weight, high strength material. For example, each of the above components of the base 18 may be formed of a metallic alloy material or a polymeric material. Regardless, the above components of the base 18 are preferably formed of a sufficiently rigid or stiff material that is capable of supporting the weight of the cooking unit 12 above the support surface 20. For example, one or more components of the base 18 may be formed of pressed sheet metal.

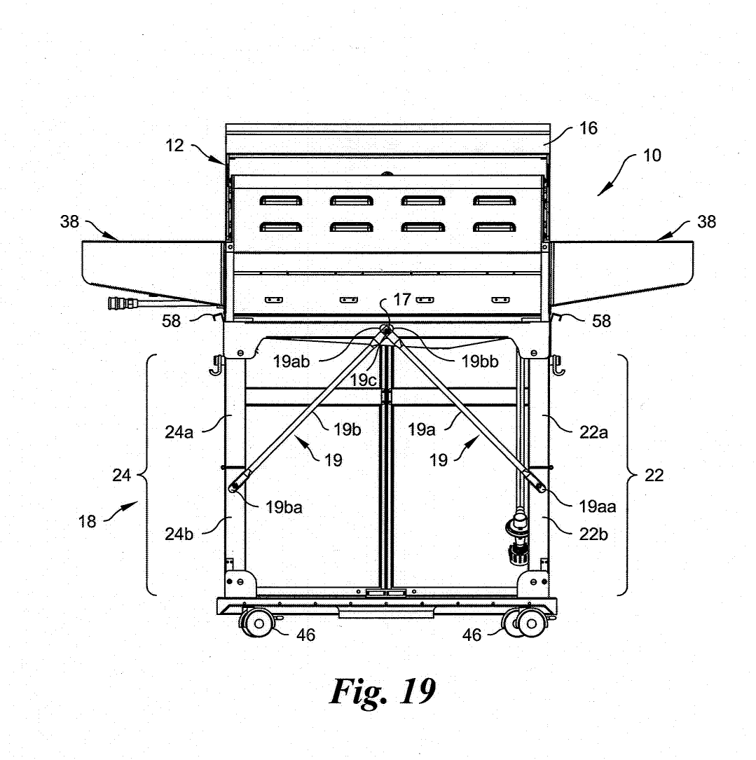

In some embodiments, the base 18 further comprises at least one brace 19 at a rear face thereof, i.e., the side opposing the door(s) 26, for stabilizing the grill in the unfolded, expanded configuration. In the illustrated embodiment, as shown in FIG. 19, the base 18 further comprises a first brace 19a and a second brace 19b. The first brace 19a is pivotably attached at one end thereof 19aa to the first side baffle 22 and has a free opposing end 19ab. Similarly, the second brace 19b is pivotably attached at one end thereof 19ba to the second side baffle 24 and has a free opposing end 19bb. Each of the free ends 19ab, 19bb of the braces 19a, 19b includes an aperture 19c therein. A cantilever pin 17 laterally projects from a generally central portion of the rear face of the top portion 18a of the base 18, relative to the first and second side baffles 22, 24. To assemble the braces 19a, 19b into the stabilizing position (FIG. 19), the braces 19a, 19b are pivotable about their first ends 19aa, 19ba to engage with the cantilever pin 17. Thus, the cantilever pin 17 projects through the aperture 19c of each of the overlapping free ends 19ab, 19bb of the braces 19a, 19b, to form an inverted V-shaped brace which locks and stabilizes the base 18 in the expanded configuration. As should be understood by those of ordinary skill in the art, the pin 17 may be a threaded pin and a fastener may be threaded onto the pin 17, atop the free ends 19ab, 19bb of the braces 19a, 19b, to maintain the braces 19a, 19b in the stabilizing position. As also should be understood by those of ordinary skill in the art, the cantilever pin 17 may alternatively project from the bottom portion 18b of the base 18, to form an up-right V-shaped brace.

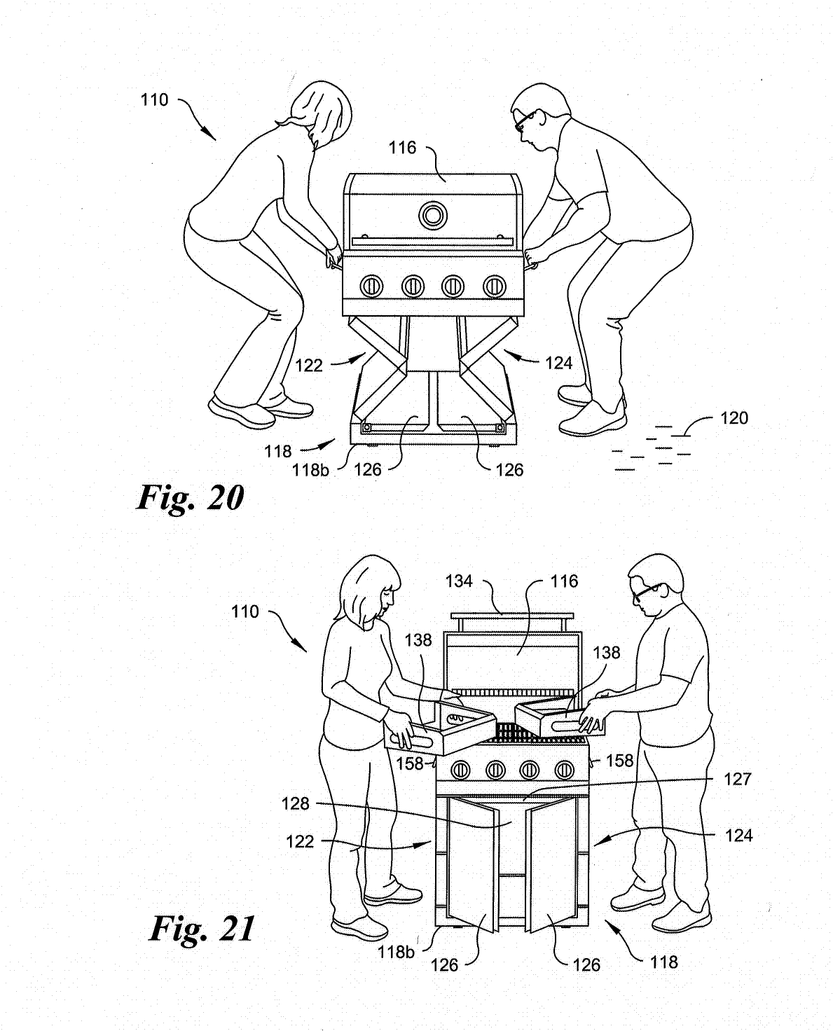

In operation, after purchasing the grill 10 from a retailer or manufacturer, for example, the user may remove any packaging that surrounds the grill 10 and possibly remove the grill 10 from a box. At this point, the grill 10 is preferably placed on the underlying surface, in the compact configuration shown in FIG. 3. To begin to assemble the grill 10, the cooking unit 12 is preferably raised upwardly (see FIG. 20 with at least a portion of the base 18 maintained in contact with the support surface), e.g., via a pair of handles 58 (FIG. 19) located on opposing sides of the exterior of the grill 10, so that the side baffles 22a, 24a, 22b, 22b are reconfigured from the folded configuration (FIG. 3), through the partially unfolded configuration (FIG. 4), and to the unfolded, expanded configuration (FIGS. 1, 2 and 5-16).

In embodiments including the brace 19, the brace 19 is moved into the stabilizing V-shaped position, to lock the grill 10 in the expanded configuration. The side baffles 22a, 24a, 22b, 22b may automatically lock into place when in the unfolded configuration, the user(s) may engage one or more locks or latches 48 (see FIG. 2), or the user(s) may thread the fastener(s) 21 onto the threaded pin(s) 25 projecting through the slot(s) 23 (see FIG. 17), to lock and maintain the side baffles 22a, 24a, 22b, 22b in the expanded configuration.

Next, either the door(s) 26 or the third rear baffle 28 may be unfolded into the desired position. For example, as shown in FIG. 6, the user may rotate the frame 27 and/or the door(s) 26 downwardly from the upper portion 18a of the base 18 and into the position shown in FIG. 7. Additionally, as shown in FIG. 8, the user may rotate the third rear baffle 28 upwardly from the lower portion 18b of the base 18 and into the position shown in FIGS. 2 and 10. In embodiments including removably attachable door(s) 26, the door(s) 26 are assembled to the base 18, i.e., the fixed lower member 26a is placed in one corresponding detent 18c and the spring loaded upper member 26b is compressed against the force of the spring to snap into the other corresponding detent 18c.

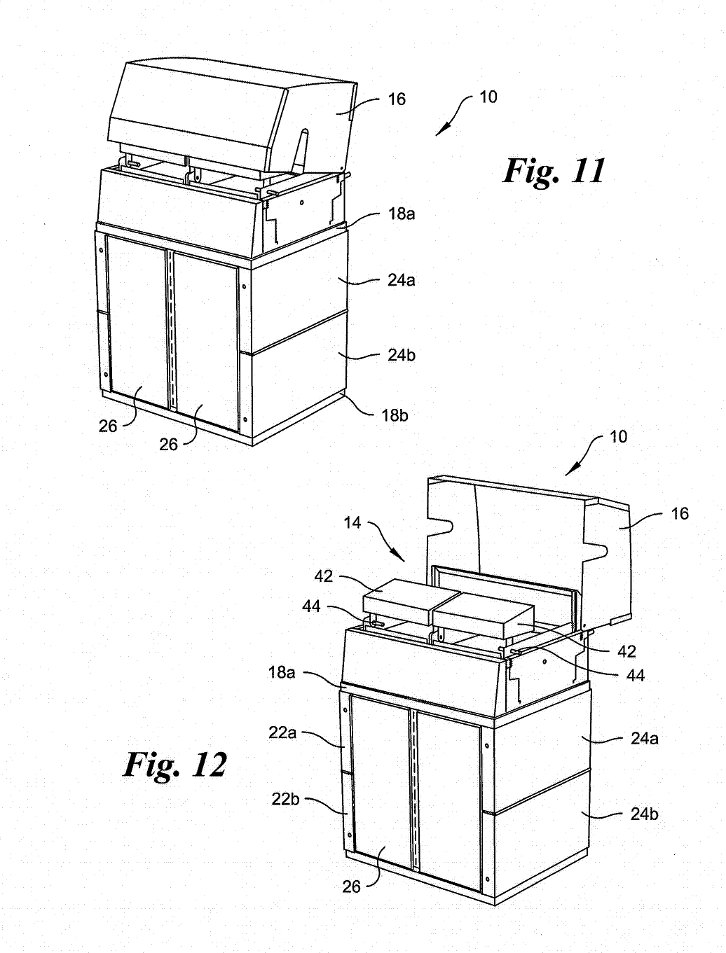

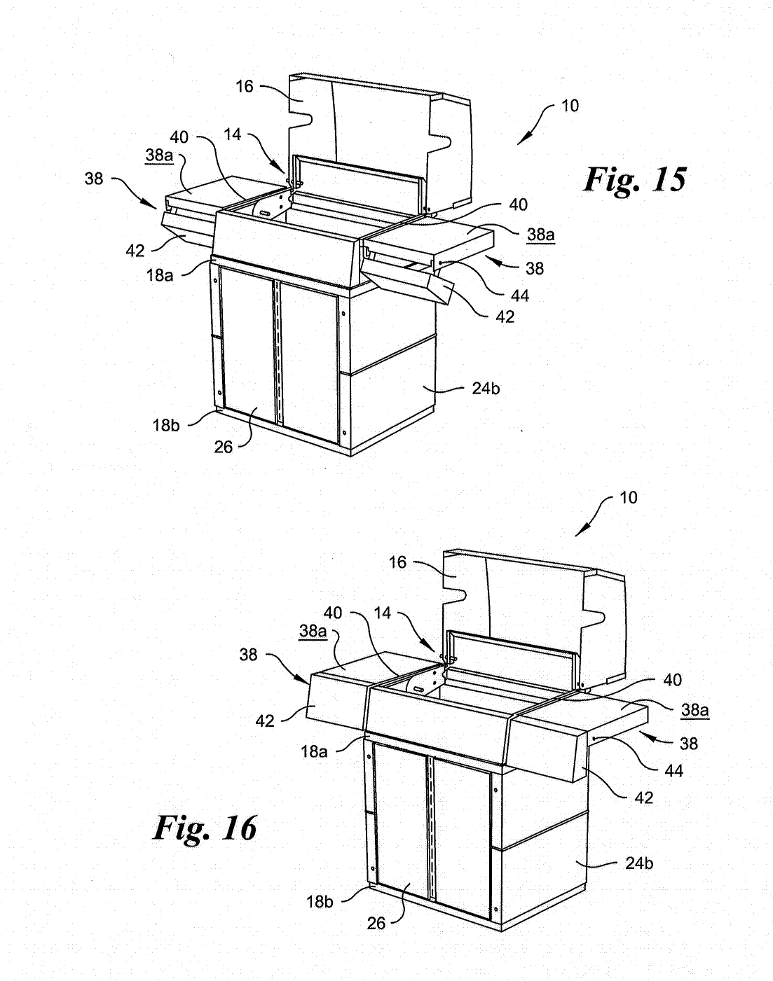

The shelves 38 may be removed, unfolded and/or attached to the exterior of the cooking unit 12 either before, after or even during assembly or unfolding of the base 18. In particular, as shown in FIGS. 11 and 12, the lid 16 is preferably first moved from the closed position to the open position to expose the shelves 38. The shelves 38 may then be rotated upwardly and/or outwardly from the heating cavity 14 through the position shown in FIG. 13 and to the position shown in FIG. 14. The tray(s) 42 may then be pivoted or unfolded into position as shown in FIGS. 15 and 16. Alternatively, the shelves 38 may be separated from the cooking unit 12 and then reattached as described below. The grill 10 may be returned to the original compact configuration of FIG. 3 by reversing the above-described steps.

FIGS. 20-22 illustrate a second preferred embodiment of a grill 110 of the present disclosure. The reference numerals of the present embodiment are distinguishable from those of the earlier embodiment by a factor of one hundred (100), but otherwise indicate the same elements as indicated above, except as otherwise specified. The grill 110 of the present embodiment is substantially similar to that of the earlier embodiment. While certain like reference numerals may be shown in FIGS. 20-22, the description of certain similarities between the embodiments may be omitted herein for the sake of brevity and convenience, and, therefore, is not limiting.

FIGS. 20-22 depict one method of assembling the grill 110, wherein the shelves 138 are removable from and reattachable to the cooking unit 112. A method of assembling the grill 110 of the second embodiment includes placing at least the bottom of the base 118 and/or the grill 110 on the support surface 120. One or more users then raise at least a portion of the grill 110, such as the cooking unit 112, upwardly with respect to the support surface 120, such that the bottom 118b of the base 118 and/or the grill 110 generally maintains contact with the support surface 120 and the legs 122, 124 of the grill 110 unfold from a compact configuration to an expanded configuration.

In particular, one or more doors 126 can be pivoted downwardly from within an interior of the grill 110 or the base 118 to form a front wall of the grill 110. The door(s) 126 is/are then preferably pivoted radially outwardly to expose at least a portion of the interior of the base 118. Either before or after the above-described movement, the third rear baffle 128 can be pivoted upwardly from within the interior of the base 118 and/or the grill 110 to form a rear wall of the base 118 and/or the grill 110. The above steps are preferably performed without the use of conventional tools.

The lid 116 of the grill 110 can be opened to expose the at least one shelf 138. As shown in FIG. 19, the shelf 138 can be removed from an interior of the of the cooking unit 112 by separating the shelf 138 from a remainder of the grill 110. As shown in FIG. 19, each shelf 138 can be attached to at least a portion of an exterior of a side of the grill 110 and/or the cooking unit 112. In particular, as shown in FIG. 18, one or more engagement members 158, such as bolts, rails, brackets or slots, may be formed in, extend outwardly from, and/or attached to a portion of the exterior of the grill 110 and/or the cooking unit 112. The engagement members 158 may be sized, shaped, positioned and/or configured to receive at least a portion of one of the shelves 138 therein to support the shelf 138 above the ground surface 120, and the shelves may thereafter be fastened to the grill, e.g., via screws. The grill 110 may be returned to the compact configuration by reversing the above-described steps.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

I/we claim:

1. A method of assembling a grill, the method comprising the steps of:
placing the grill in a compact configuration on an underlying support surface, such that a base of the grill engages the support surface with opposing first and second side baffles of the base extending generally parallel to the support surface;
raising an upper portion of the grill upwardly with respect to the support surface and maintaining at least a lower portion of the base in contact with the support surface, such that the first and second side baffles unfold from the compact configuration to an expanded configuration of the base, the first and second side baffles extending generally perpendicularly to the support surface to support the upper portion of the grill; and
installing at least one brace to stabilize the grill in the expanded configuration.

2. The method of claim 1, wherein the installing step comprises:
engaging a free end of a first brace, pivotably attached at an opposing end thereof to the first side baffle, with a cantilever pin projecting from a generally central portion of the grill relative to the first and second side baffles; and
engaging a free end of a second brace, pivotably attached at an opposing end thereof to the second side baffle, with the centrally located cantilever pin, thereby forming a generally V-shaped brace, locking the base in the expanded configuration, the first and second braces stabilizing the grill.

3. The method of claim 1, wherein the raising step comprises raising a portion of the grill upwardly using at least one of a pair of handles located on opposing sides of an exterior surface of the grill.

4. The method of claim 1, wherein each of the first and second side baffles includes an upper plate pivotably attached to a lower plate, each lower plate having at least one threaded pin extending from an upper end of the lower plate and each upper plate having a corresponding at least one slot in a lower end of the upper plate, and wherein movement of the first and second side baffles from the compact configuration to the expanded configuration moves the at least one threaded pin to project through the at least one slot, and further comprising the step of installing a fastener onto the at least one threaded pin of each lower plate to secure the first and second side baffles in the expanded configuration.

5. The method of claim 1, further comprising the step of attaching at least a portion of a shelf to at least a portion of an exterior of the grill.

6. The method of claim 1, further comprising the step of pivotably attaching at least one door to a front face of the base of the grill.

7. The method of claim 6, wherein the at least one door includes a fixed arcuate shaped member projecting from a lower corner of the door and a spring loaded arcuate shaped member projecting from an axially spaced upper corner of the door, and wherein the base of the grill includes opposing detents corresponding to each of the arcuate shaped members, and wherein the step of pivotably attaching the at least one door comprises mating the fixed arcuate shaped member of the door with the corresponding detent in the base and compressing the spring loaded arcuate shaped member to engage the corresponding opposing detent in the base.

8. A quick-assemble grill comprising:
a cooking unit defining a heating cavity for receiving and heating foodstuff, the cooking unit including a lid for selectively opening and closing the heating cavity; and
a base supporting the cooking unit atop a support surface, the base including a first side baffle and an opposing second side baffle, wherein the first and second side baffles are movable between a compact configuration, wherein the first and second side baffles extend generally parallel to the support surface, and an expanded configuration, wherein the first and second side baffles extend generally perpendicularly to the support surface, and
at least one brace for stabilizing the grill in the expanded configuration.

9. The quick-assemble grill of claim 8, wherein the at least one brace comprises a first brace pivotably attached at one end thereof to the first side baffle and having a free opposing end, and a second brace pivotably attached at one end thereof to the second side baffle and having a free opposing end, each of the free ends of the first and second braces being engageable with a cantilever pin projecting from a generally central portion of the grill relative to the first and second side baffles, to, in turn, form a generally V-shaped brace for locking and stabilizing the base in the expanded configuration.

10. The quick-assemble grill of claim 8, wherein each of the first and second side baffles further includes an upper plate pivotably attached to a lower plate, wherein in the compact configuration the plates extend generally parallel to one another and to the support surface, and in the expanded configuration the plates extend generally parallel to, and abutting, one another and generally perpendicularly to the support surface.

11. The quick-assemble grill of claim 8, wherein each of the first and second side baffles further includes an upper plate pivotably attached to a lower plate, each lower plate having at least one threaded pin extending from an upper end of the lower plate and each upper plate having a corresponding at least one slot in a lower end of the upper plate, and wherein movement of the first and second side baffles from the compact configuration to the expanded configuration moves the at least one threaded pin to project through the at least one slot.

12. The quick-assemble grill of claim 11, further comprising at least one fastener for threading onto the corresponding at least one threaded pin in the expanded configuration of the base, to secure the first and second side baffles in the expanded configuration.

13. The quick-assemble grill of claim 8, further comprising a pair of handles located on opposing sides of an exterior of the grill for raising the base from the compact configuration to the expanded configuration.

14. The quick-assemble grill of claim 8, further comprising at least one shelf removably attachable to at least a portion of an exterior of the grill.

15. The quick-assemble grill of claim 8, further comprising at least one door pivotably attached to a front end of the base.

16. The quick-assemble grill of claim 15, wherein the at least one door includes a fixed arcuate shaped member projecting from a lower corner of the door and a spring loaded arcuate shaped member projecting from an axially spaced upper corner of the door, and the base of the grill further includes opposing detents corresponding to each of the arcuate shaped members, for mating therewith.
